(19) United States
(12) Patent Application Publication
(10) Pub. No.: US 2013/0128120 A1
(43) Pub. Date: May 23, 2013

(54) Graphics Pipeline Power Consumption Reduction

(71) Applicant: Rupen Chanda, San Francisco, CA (US)

(72) Inventor: Rupen Chanda, San Francisco, CA (US)

(21) Appl. No.: 13/082,976

(22) Filed: Apr. 8, 2011

Related U.S. Application Data
(60) Provisional application No. 61/472,542, filed on Apr. 6, 2011.

(51) Int. Cl. H04N 9/74

(52) U.S. Cl. 348/600; 348/E09.055

(57) ABSTRACT

A graphics pipeline may be partially or completely shut down based, at least in part, on the presence of non-transparent objects in a graphics layer. Any regions of the graphics layer that include one or more non-transparent objects (e.g., semi-transparent, opaque, etc.) may be determined. A video layer and the determined regions of the graphics layer may be sampled. The sampled video layer and the sampled determined regions of the graphics layer may be composited for display. In some instances, it may be determined that the graphics layer includes no non-transparent objects. Upon that determination, the graphics pipeline may be fully shut down and the video layer may be sampled and composited, without sampling and/or compositing the graphics layer.

### PRIORITY INFORMATION

This application claims benefit of priority of U.S. Provisional Application Ser. No. 61/472,542 entitled “Graphics Pipeline Power Consumption Reduction” filed Apr. 6, 2011, the content of which is incorporated by reference herein in its entirety.

### BACKGROUND

1. Technical Field

This disclosure relates generally to media playback, and more specifically, to power consumption in media playback.

2. Description of the Related Art

Accelerated video playback of multimedia content typically draws upon the resources of multiple hardware components, such as central processing units (CPUs), graphics processing units (GPUs), dedicated video cards, etc. With the use of multiple hardware components to process and display multimedia content, power consumption by those multiple hardware components can be significant.

### SUMMARY

This disclosure describes techniques and structures for partially or completely shutting down a graphics pipeline. In one embodiment, content, such as multimedia content, may be received. Multimedia content may include graphics content rendered as a graphics layer and video content rendered as a video layer. Any regions of the graphics layer that include one or more non-transparent objects (e.g., semi-transparent, opaque, etc.) may be determined. The video layer may be sampled and the determined regions of the graphics layer may be sampled without sampling regions of the graphics layer not containing one or more non-transparent objects. The sampled video layer and the sampled graphics layer corresponding to the determined regions may be composited for display.

In one embodiment, it may be determined that the graphics layer includes no non-transparent objects. Upon that determination, the graphics pipeline may be fully shut down and the video layer may be sampled and composited without sampling and compositing the graphics layer at all.

### BRIEF DESCRIPTION OF THE DRAWINGS

FIG. 1 is a flowchart of a method for partially or completely shutting down a graphics pipeline, according to some embodiments.

FIG. 2 is a flowchart of a method for completely shutting down a graphics pipeline, according to some embodiments.

FIGS. 3A-3B illustrate example full-screen mode screenshots of a media player, according to some embodiments.

FIG. 4 illustrates a block diagram of one embodiment of partially or completely shutting down a graphics pipeline.

FIG. 5 illustrates a block diagram of another embodiment of partially or completely shutting down a graphics pipeline.

FIG. 6 illustrates an example computer system that may be used in embodiments.

While the disclosure is described herein by way of example for several embodiments and illustrative drawings, those skilled in the art will recognize that the disclosure is not limited to the embodiments or drawings described. It should be understood, that the drawings and detailed description thereto are not intended to limit the disclosure to the particular form disclosed, but on the contrary, the intention is to cover all modifications, equivalents and alternatives falling within the spirit and scope of the present disclosure. The headings used herein are for organizational purposes only and are not meant to be used to limit the scope of the description. As used throughout this application, the word “may” is used in a permissive sense (e.g., meaning having the potential to), rather than the mandatory sense (e.g., meaning must). Similarly, the words “include”, “including”, and “includes” mean including, but not limited to.

### DETAILED DESCRIPTION OF EMBODIMENTS

### Incorporation by Reference

The following reference is hereby incorporated by reference in its entirety as though fully and completely set forth herein: U.S. patent application Ser. No. 13/035,624, titled “Independent Layered Content for Hardware-Accelerated Media Playback”, filed on Feb. 25, 2011.

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

“First,” “Second,” etc. As used herein, these terms are used as labels for nouns that they precede, and do not imply any type of ordering (e.g., spatial, temporal, logical, etc.). For example, in a processor having eight processing elements or cores, the terms “first” and “second” processing elements can be used to refer to any two of the eight processing elements. In other words, the “first” and “second” processing elements are not limited to logical processing elements 0 and 1.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

Various embodiments of methods and apparatus for partially or completely shutting down a graphics pipeline are described. Some embodiments may include a means for shutting down sampling a graphics content layer and a means for shutting down compositing graphics content for display. For example, a sampling module may receive various content layers as input and sample the layers into respective buffers. A compositing module may composite data from the respective buffers for display. The sampling and compositing modules may, in some embodiments, be implemented by program instructions stored in a computer-readable storage medium and executable by one or more processors (e.g., one or more CPUs or GPUs) of a computing apparatus. The computer-readable storage medium may store program instructions executable by the one or more processors to cause the computing apparatus to perform receiving various content layers (e.g., graphics, video, 3D, etc.) as input, determining any regions of the graphics layer that include one or more non-transparent objects, sampling the layers into respective buffers, and compositing data from the respective buffers for display, as described herein. Other embodiments of the compositing and sampling modules may be at least partially implemented by hardware circuitry and/or firmware stored, for example, in a non-volatile memory.

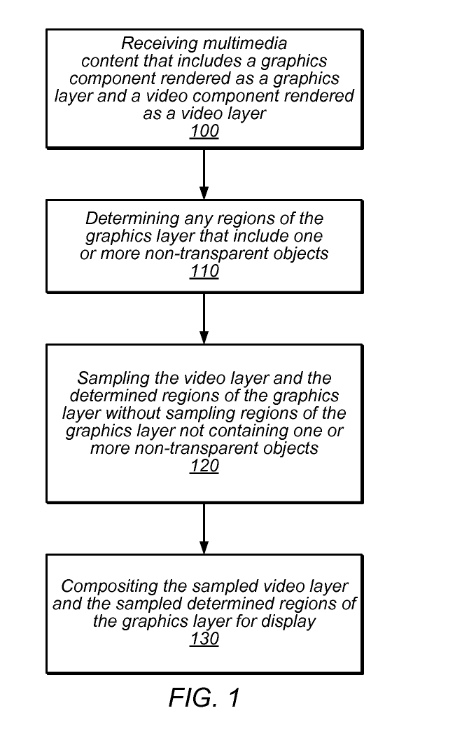

Turning now to FIG. 1, one embodiment for partially or completely shutting down a graphics pipeline is shown. While the blocks are shown in a particular order for ease of understanding, other orders may be used. In some embodiments, the method of FIG. 1 may include additional (or fewer) blocks than shown. Blocks 100-130 may be performed automatically or may receive user input.

As indicated at 100, multimedia content, which may include a graphics layer and a video layer, may be received. In one embodiment, the received graphics and video layers may be rendered as two separate layers, which may facilitate hardware acceleration. The graphics layer may include rendered graphics content, such as two-dimensional (2D) content, regular vector graphics, bitmap images, RGB data, text, images, animations, etc. In one embodiment, the graphics layer may include one or more transparent objects with corresponding transparent regions (e.g., alpha transparent blank pixels). The transparent region may allow video content to show through to the top, or at least as close to the top as originally authored. As an example, a graphics content layer may include a small watermark image (e.g., a brand of the content provider/developer), which may be displayed on top of the video content layer. The remainder of the graphics layer, other than the region containing the watermark image, may include a plurality of transparent regions. In some embodiments, the graphics layer, including such a watermark image, may be overlaid on top of video content in a full-screen mode of a multimedia player. Full-screen mode is used herein to describe a mode that allows the multimedia content to fill an entire display without any container borders or menus.

The video layer may include rendered video content. Video content may include hardware accelerated or hardware decoded video. In one embodiment, video content may be encoded using an accelerated codec (e.g., H.264). Video encoded with an accelerated codec may facilitate full GPU acceleration through display. Multimedia content may additionally include a three-dimensional (3D) layer that may include rendered 3D vector graphics content. Accordingly, the received multimedia content may include other layers in addition to the graphics and video layers, described herein. For example, the received multimedia content may include a 3D graphics layer. In one embodiment, video content may be rendered as YUV (Y′UV) data.

The content layers may be rendered independently (e.g., the graphics content layer and the video content layer may be rendered using separate hardware). In this way, each layer may be updated independently with its own timer, e.g., asynchronously. The video layer, in some embodiments, may be rendered on a dedicated chip in a system. For example, video may be rendered using a specific hardware video decoding chip or GPU that may drive the video layer completely. This may allow full GPU acceleration of the video, from decoding to presentation. In one embodiment, the video may be on a hardware plane underneath a central processing unit (CPU) plane. Accordingly, when the video changes, the rendering may be updated on the hardware plane but the video may not be copied back from the hardware plane to the CPU. Thus, the CPU may not have to render anything when the video changes. As a result, the video content layer may never interact with the CPU and may take advantage of hardware acceleration. Further, read-back (e.g., sending data from GPU to the CPU) may not be necessary to composite the video frames. The hardware decoder may skip operations that would otherwise require use of software in a CPU. In one embodiment, the video may be pre-rendered before run time or display time. Additionally, the video layer may include multiple video sub-layers. In some embodiments, however, only one video of multiple videos may be composited at a time (e.g., on mobile devices). Further, actual video may or may not take up the full video layer. In one embodiment, video frames may not be presented inside the display list but rather inside a texture sitting behind the stage painted through the GPU. This may allow content available on the graphics card memory to be directly painted on screen. In one embodiment, the various content layers may update asynchronously. For example, video content may be updated at 20 frames per second (fps), while a vector layer (e.g., a subtitle layer) may update every 2 seconds. Updating asynchronously may avoid sync issues by allowing video to play at its frame rate, be decoded by hardware and presented at an appropriate frame rate while, at the same time, other elements may be updated independently and presented at a higher rate. At a given time t, all layers may present a correct or appropriate state. Thus, rendering may occur at an appropriate rate. A media player may provide a global time that may further facilitate correct rendering.

The various layers of multimedia content may be represented by a display list. A display list may be used to describe how graphical elements are composited together. In other words, the display list may be used as a display graph. The display list may include a hierarchical representation of the contents of any vector graphics or video (or 3D vector graphics). An object in the display list may include sub-objects that represent vector graphics, video, or 3D graphics. The display list may also include a depth that may indicate the compositing/layering order. In one embodiment, the display list may include only non-video content (e.g., graphics objects), with video content on a video plane behind the display list.

In one embodiment, multimedia content may include intermixed layers (e.g., layers that include different types of content, such as a layer that includes both vector graphics and video) that may be separated into separate layers. Thus, a layer that originally included both vector graphics and video content may be separated into a graphics layer and a video layer. The video layer may reside behind the CPU plane and the graphics layer may be overlaid on top of the video layer. The graphics layer may include an alpha transparent portion corresponding to the respective location of the video content. The separated graphics and video layers may be the layers received at block 100.

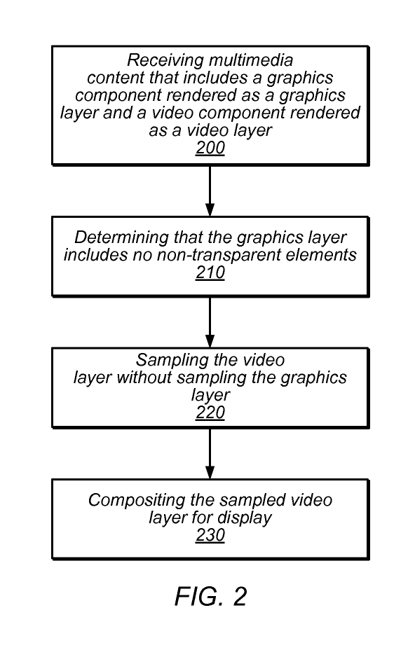

At 110, any regions of the graphics layer that include one or more non-transparent objects may be determined. In one embodiment, the graphics layer may include one or more non-transparent objects (e.g., semi-transparent, opaque, etc.). The display list may include a graphics state that may be provided to a display controller indicating the presence and/or absence of any non-transparent objects in the graphics layer. In one embodiment, a multimedia player executed by a central processing unit (CPU) may provide the graphics state to the display controller. The graphics state may be an indication that no non-transparent objects exist in the graphics layer (e.g., only transparent objects exist). In such an example, the graphics state may be used to completely shut down the graphics pipeline for the graphics content layer, as described at FIG. 2. In another example, the graphics state may provide an indication that one or more non-transparent objects are present in the graphics layer. Accordingly, the display list may be searched for regions containing the non-transparent objects. In one embodiment, the display list may not actually include a graphics state indication. Instead, the display list may be searched for semi-transparent and opaque objects by the multimedia player, for example. Or, the multimedia player may search the display list for transparent objects. In either case, the display list search may result in determining the regions (e.g., position and size) corresponding to the one or more non-transparent objects of the plurality of objects in the display list. The regions corresponding to the one or more non-transparent objects may be rectangular, substantially rectangular, or other polygon-shaped region. The display list may change from frame to frame such that, in one frame, various non-transparent objects may be present while, in a subsequent frame, no non-transparent objects may be present. The regions may be determined each frame or at some other periodic interval.

As shown at 120, the video layer and the determined regions of the graphics layer may be sampled without sampling regions of the graphics layer not containing one or more non-transparent objects. Sampling the graphics layer may include sampling a display frame buffer and sampling the video layer may include sampling a video frame buffer. In one embodiment, the sampling of block 120 may be performed by a display controller. In one embodiment, the display controller may receive an indication from a media player running on a CPU that indicates which regions of the graphics layer contain non-transparent objects. For example, the media player may compute a cumulative list of rectangles representing regions of the graphics layer having opaque or semi-transparent elements. In one embodiment, the media player may compute the cumulative list from searching the display list. The media player may then provide the cumulative list and/or the graphics state to the graphics controller. In one embodiment, the multimedia player may provide the graphics state and/or cumulative list to both a GPU and display controller. As a result, the display controller may directly shut down sampling of the regions containing only transparent objects. Thus, the display controller, when non-transparent objects exist in the graphics layer, may sample the video layer and only the regions of the graphics layer that include one or more non-transparent objects. Accordingly, the remaining portion of the graphics layer sampling may be shut down, which may result in power savings.

In one embodiment, the display controller may sample the video frame buffer and display frame buffer at every vertical synchronization (v-sync) (e.g., 60 Hz). In one embodiment, a multimedia player running on a CPU may provide the graphics state and/or a cumulative list of rectangles containing semi-transparent or opaque graphics elements to the display controller. The display controller may sample only those portions of the display frame buffer corresponding to the list of rectangles. Thus, the remaining sampling of the graphics pipeline may be shut down, which may conserve power. The partial shut down of the sampling of the graphics pipeline may be used in conjunction with partially shutting down the compositing of the display pipeline. In other words, shutting down the graphics pipeline may include shutting down sampling of a portion of the graphics layer as well as shutting down a portion of the compositing the graphics layer with the video layer such that only certain sampled portions of the graphics layer may be composited with the sampled video layer. Shutting down the graphics pipeline may also include shutting down rendering of the graphics layer. For example, if the graphics layer only includes transparent pixels, the multimedia player may provide an indication to the hardware rendering the graphics layer to shut down (partial or complete) rendering the graphics layer. In one embodiment, the multimedia player may provide indication that no non-transparent objects are present in the graphics layer. In such an embodiment, the display controller may completely shut down sampling the graphics pipeline such that only the video frame buffer may be sampled. As described herein, the proportion of the graphics pipeline that is shut down may be directly proportional to any power savings that result. Thus, a complete shutdown of sampling the graphics pipeline may result in additional power savings over a partial shutdown.

In other embodiments, the display controller may sample the video frame buffer at every v-sync but may sample the display frame buffer at other periodic intervals. For example, the non-transparent object represented in the display frame buffer may be a static image, such as a watermark. As a result, at rendering or compositing, the multimedia player, or other component, may determine that a non-transparent object is static or will be static for a period of time. The display controller may completely shutdown the graphics display pipe (compositing and/or sampling) periodically, for example, during the static time period, even with the existence of some non-transparent objects.

Block 120 may also include rendering the various content into separate content layers (e.g., rendering graphics content into a graphics layer and video content into a video layer), if not performed at 100 or before (pre-rendered). Rendering of each layer may be performed separately by different hardware resources. For instance, the graphics layer may be rendered by a CPU and the video layer may be rendered by a GPU or video decoder. Other layers (e.g., a 3D graphics layer) may be rendered by a separate hardware resource as well or may utilize the same hardware resource that rendered the video layer. In some embodiments, shutting down the graphics pipeline may include fully or partially shutting down the rendering of one or more content layers. For example, if the graphics content includes no non-transparent objects, the hardware performing the rendering of the graphics layer may be shut down in addition to shutting down sampling of the graphics layer.

As illustrated at 130, the video frame buffer and the display frame buffer may be composited for display. Composition may be performed, in one embodiment, by a GPU. The GPU may be a dedicated piece of hardware for performing composition of the content layers or it may be built-in to a GPU that rendered one of the content layers. In other embodiments, composition may be performed by the display controller that performs the sampling. In other embodiments, composition may be performed by an overlay engine, which may be external to the display controller. Compositing may be performed with alpha blending from the bottom to the top layer so that the layers may interact. In one embodiment, at display time, the hardware that rendered the video may feed frame by frame of the video to the GPU, display controller, or overlay engine to be composited with the other layers. In this manner, video may be flexible by frame rate or by switching between streams. In some embodiments, the GPU may include one or more buffers and a piece of hardware that performs the blending. In some embodiments, an API may perform the blending. In other embodiments, a display controller may perform the blending. As described above, the layers may be updated asynchronously. This may allow all layers to be properly displayed regardless of which layer is updated. In embodiments with 3D content, the 3D content may utilize GPU anti-aliasing as the 3D content is moved to the final display.

In one embodiment, the GPU or overlay engine may receive an indication of which regions of the graphics layer contain non-transparent objects. For example, the GPU or overlay engine may receive the indication from a media player on a CPU or display controller. Where the same hardware (e.g., display controller) performs the sampling of block 120 and the compositing of block 130, a separate indication may not be received. Instead, in one embodiment, a graphics state may be received by the display controller that may indicate the presence of non-transparent objects. When the compositing is performed by separate hardware than the hardware performing the sampling (e.g., an overlay engine performing the compositing and a display controller performing the sampling), delays may exist in the form of providing an indication of the graphics state or cumulative list to the overlay engine to shut down compositing. In response to receiving the indication, the overlay engine (or GPU) may composite the video layer and only the regions of the graphics layer that include one or more non-transparent objects. Accordingly, the remaining portion of the graphics layer compositing may be shut down, which may result in power savings. The resulting power savings may be proportional to the area of the graphics layer containing only transparent objects. Consider two examples: a first where a region of non-transparent objects (e.g., watermark, subtitles, etc.) cover 10% of the graphics layer and a second where a region of non-transparent objects covers 50% of the graphics layer. Under blocks 120-130, only the corresponding 10% or 50% of the graphics layer may be sampled and composited. As a result, the 10% example may result in more power savings than the 50% example, which, in turn, may result in power savings over a system that does not perform a partial or complete graphics pipeline shut down.

In one embodiment, shutting down the sampling of the graphics pipeline may allow for a modified compositing technique. For example, in one embodiment, compositing may be shut down for regions of the graphics layer in which sampling was shut down. As a result, for the shut down regions, only the sampled video may be provided for display. Other regions that include sampled graphics (regions that were not shut down) may be composited in a normal fashion. The indication received by the overlay engine (or GPU), if performing the compositing, or the graphics state received by the display controller may include instructions to modify compositing in accordance with which regions of the graphics layer include non-transparent objects. Such modified compositing may ensure that the end display is not corrupted.

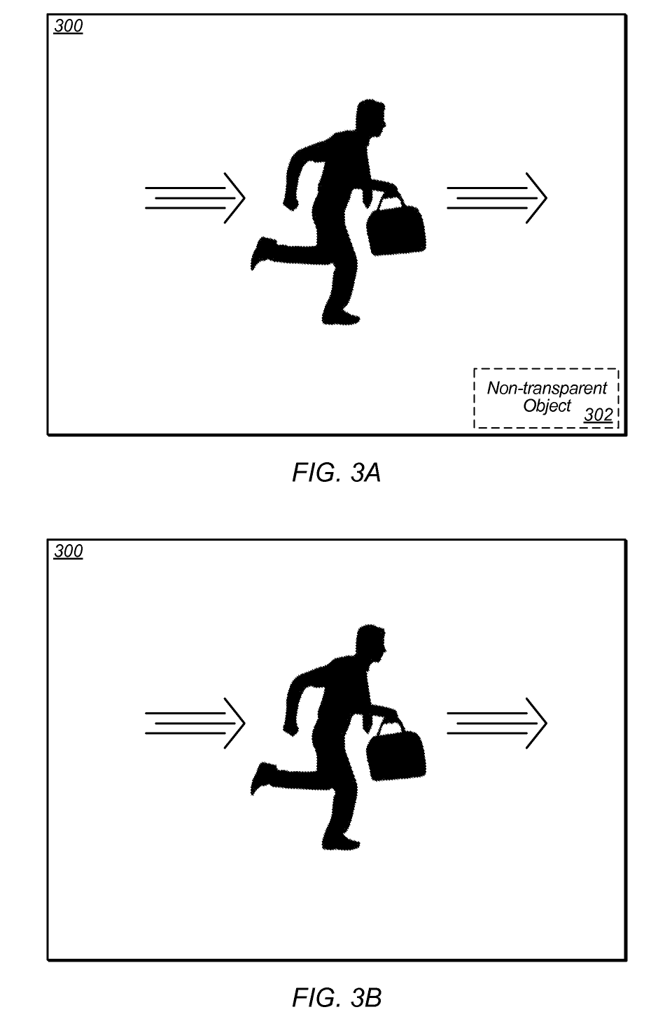

FIG. 3A illustrates an example full-screen mode screenshot of a media player, according to some embodiments. After a period of time from the last user activity (e.g., 2 seconds), video content layer 300, which in the example includes video content of a man running with his suitcase, may be displayed with some non-transparent graphics object 302 overlaid. As used herein, user activity may include a user input, such as manipulating a mouse, touch screen, or other pointing device. As shown, a constant watermark, subtitles, animation, or other graphics represented by non-transparent object 302 may be overlaid on top of the video layer 300 after the inactivity period. The media player may provide indication that some non-transparent graphics elements 302 are present to the display controller and may also provide a cumulative list of the regions (e.g., rectangles, as indicated in FIG. 3A by the hashed rectangle around non-transparent object 302) that include non-transparent graphics elements 302 to the display controller. The display controller may partially shut down the graphics pipeline. In doing so, the display controller may stop sampling and/or compositing the portion of the graphics pipeline corresponding to the regions of the graphics plane not in the cumulative list (e.g., all regions other than the region of non-transparent object 302). In other words, the display controller may stop sampling and/or compositing regions of the graphics pipeline containing only transparent elements. Current consumption by the graphics pipeline may be linearly dependent on the area the display controller samples. Thus, if the display controller only has to sample 10% of the display pipe, then the amount of power consumed to sample the display pipe may be 10% of the amount of power consumed to sample the entire display pipe.

By partially or completely shutting down the graphics pipeline, power savings may be achieved. Power savings may be extremely valuable in certain devices, such as devices using battery power (e.g., mobile devices). As described herein, the amount of power consumed for a display pipe may be commensurate to the proportion of the display pipe sampled and/or composited. Thus, to display multimedia content from a website that offers video content with a small watermark overlay, significant power savings may be achieved because only a small portion of the graphics layer may be utilized in such a case.

Turning now to FIG. 2, one embodiment for completely shutting down a graphics pipeline is shown. While the blocks are shown in a particular order for ease of understanding, other orders may be used. In some embodiments, the method of FIG. 2 may include additional (or fewer) blocks than shown. Blocks 200-230 may be performed automatically or may receive user input.

As illustrated at 200 and similar to block 100, multimedia content, which may include a graphics layer and a video layer, may be received. As at 100, the received graphics and video layers may be rendered as two separate layers or may be separated into different layers. In one embodiment, the graphics layer may consist entirely of alpha transparent blank pixels. Thus, in a full screen mode of a multimedia player, the transparent content of the graphics layer, overlaid on top of the video layer, may not be apparent to a viewer of the player because the video may be fully viewable with nothing obstructing any part of the video layer. As at 200, the various layers may be represented by a display list.

As shown at 210, it may be determined that the graphics layer includes no non-transparent elements. In one embodiment, a multimedia player, executed on a CPU of the computing device, may determine that no non-transparent elements (e.g., semi-transparent, opaque, etc.) are present in the graphics layer. In one embodiment, the multimedia player may make such a determination by searching the display list. The multimedia player may provide indication to the display controller and/or an overlay engine and/or GPU that no non-transparent elements are present in the graphics layer.

At 220, the video layer may be sampled into the video frame buffer without sampling the graphics layer. In one embodiment, sampling is performed with the same hardware that performs the compositing of block 230. For instance, that piece of hardware may be a display controller. Upon receiving indication from the multimedia player that no non-transparent elements are present in the graphics layer, the display controller may shut down sampling of the graphics layer into the display frame buffer. As a result, the display controller may sample only the video layer into the video frame buffer. In one embodiment, the video frame buffer may be sampled at every v-sync (e.g., every 60 Hz). Because only the video frame buffer may be sampled, the graphics pipeline may be shut down. In some embodiments, the compositing of block 230 is performed by hardware other than a display controller (e.g., an overlay engine, GPU, etc.). In such embodiments, the display controller and/or the multimedia player may provide an indication to the other hardware that no non-transparent elements are present in the graphics layer such that the other hardware may not composite the graphics layer into the display frame buffer.

As shown at 230, the video frame buffer may be composited for display. Accordingly, the compositing of the sampled graphics layer may be shut down as one part of the graphics pipeline shut down. Shutting down the graphics pipeline may include shutting down compositing the graphics layer, shutting down sampling the graphics layer in block 220, and or shutting down rendering of the graphics layer. As a result of the shut down, power savings may be achieved. At a later point in time, the display controller may receive indication that the graphics layer has changed and a non-transparent element may then be present in the display list. At that point, the display controller, multimedia player, and any other component may proceed to blocks 110-130 of FIG. 1. Thus, at one point in time, the graphics pipeline may be completely shut down and at another time, the graphics pipeline may be partially shut down, depending on whether or not non-transparent objects are present at the time the multimedia player searches the display list. In other words, the determined regions having non-transparent objects may change from frame to frame.

FIG. 3B illustrates an example full-screen mode screenshot of a media player, according to some embodiments. After a period of time of user inactivity (e.g., 2 seconds) or initially and until the media player receives user activity, video content layer 300 may be displayed without any overlaid non-transparent graphics elements. Compare FIG. 3B with FIG. 3A where non-transparent object 302 was present in the lower right portion of the full-screen display. In contrast, FIG. 3B show graphics elements that are fully transparent. The media player may provide indication that all graphics elements are fully transparent (or that no non-transparent elements are present) to the display controller and/or an overlay engine and/or a GPU. The display controller may completely stop sampling the graphics pipeline and likewise stop compositing the graphics pipeline. By completely shutting down the graphics pipeline, even greater power savings may be achieved over a partial shut down. In one instance, current consumption may be reduced over 50% by completely shutting down sampling the graphics pipeline. For example, when using H264 video playback, current consumption may drop from 10 mA to 4 mA as a result of not sampling the graphics pipeline. Thus, for a website that offers video content with no overlaid graphics content, significant power savings may be achieved by shutting down a graphics pipeline that would otherwise be sampling transparent objects that a user of the media player would not even see.

### Example Implementations

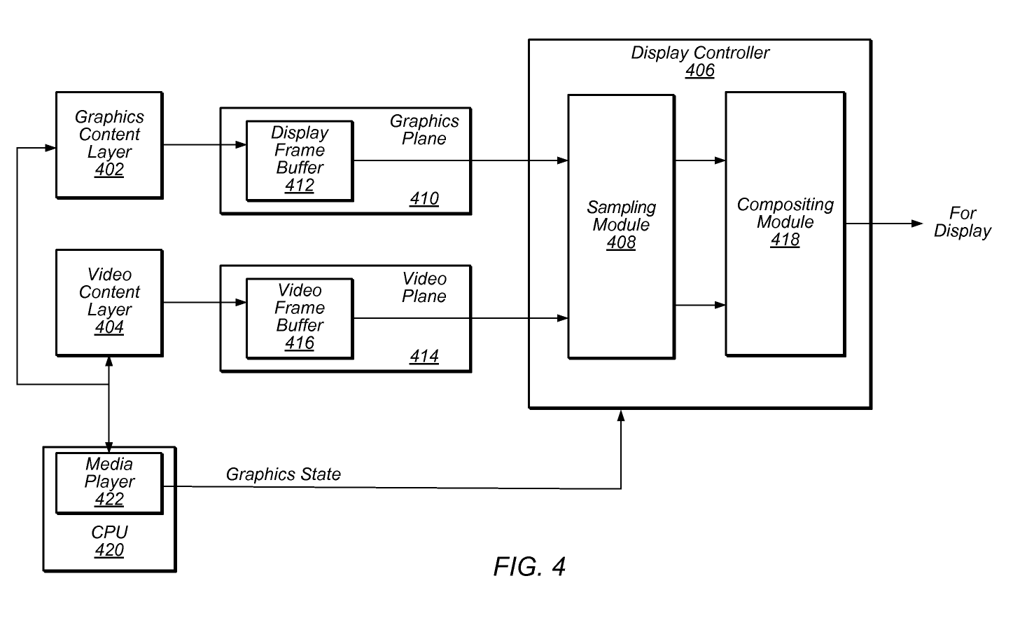

FIG. 4 illustrates a block diagram of one embodiment of partially or completely shutting down a graphics pipeline. In one embodiment, media player 422, which may be executed on CPU 420 of a computing device, may compute a cumulative list of regions of graphics layer 402 that contains non-transparent objects (e.g., opaque or semi-transparent elements). As one example, media player 422 may search a display list for such objects. Media player 422 may provide a state indicating the presence or absence of any non-transparent objects to display controller 406. In addition, media player 422 may also provide the cumulative list of regions containing non-transparent objects, which may be rectangles or other polygons, to display controller 406. Not shown, media player 422 may instead search display frame buffer 412 of graphics plane 410 to determine a graphics state and/or the cumulative list of rectangles. Display controller 406 may include sampling module 408 and compositing module 418 that may implement one or more of the compositing and sampling techniques illustrated in FIGS. 1, 2, and 3a-3b. Sampling module 408 may sample graphics layer 402 and video layer 404 into respective buffers. In one embodiment, sampling module 408 may sample graphics layer 402 (e.g., from display frame buffer 412 of graphics plane 410). Sampling module 408 may also sample video layer 404 (e.g., from video frame buffer 416 of video plane 414). Sampling module 408 may sample both buffers at every v-sync (e.g., 60 Hz) for display. In one embodiment, sampling module 408 may detect, or receive indication that an object of the graphics plane may be static. Accordingly, sampling module 408 may reduce the sampling rate of display frame buffer 412 while still sampling video frame buffer 416 at 60 Hz. Compositing module 418 may composite display frame buffer 412 and video frame buffer 416 for display.

Based on the received graphics state and/or cumulative list of regions of non-transparent objects, display controller 406 may partially or completely shut down the graphics pipeline, as described herein. Partially shutting down the graphics pipeline may include compositing and sampling only the regions containing non-transparent objects, in addition to compositing and sampling the video pipeline. Completely shutting down the graphics pipeline may include compositing and sampling only the video pipeline.

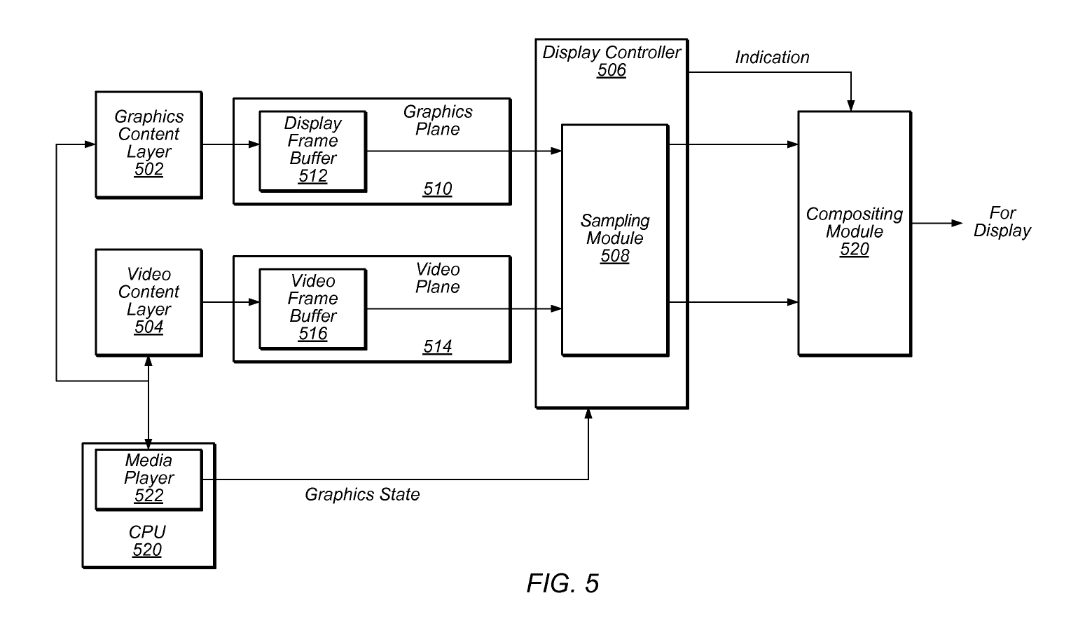

FIG. 5 illustrates a block diagram of an alternative embodiment of partially or completely shutting down a graphics pipeline. FIG. 5 is substantially the same as FIG. 4 with a few differences. In some circumstances, access may not be available to a renderer. In such a circumstance, compositing may not take place in the display controller, but instead may take place in a compositing module 520, for example, in an overlay engine (not shown). In one embodiment, compositing module 520 may composite the sampled data and provide the composited sampled data directly to the display, or compositing module 520 may provide the composited data back to the display controller to pass through to the display. As shown, display controller 506 may not include compositing module 520 as in FIG. 4. Instead, compositing module 520 may be external to display controller 506, for example, in an overlay engine. Accordingly, when media player 522 provides a graphics state and/or list of cumulative regions containing non-transparent objects to display controller 506, display controller 506 may not directly shut down compositing the graphics pipeline. Instead, as indicated, display controller 506 or multimedia player 522 may provide an indication to compositing module 520 whether to completely or partially shut down compositing the graphics pipeline. The power savings achieved by a system according to FIG. 5, may not be as significant as the power savings achieved by a system according to FIG. 4, due in part to a delay in shutting down compositing the graphics pipeline. Nevertheless, power savings may be achieved in both systems.

### Example System

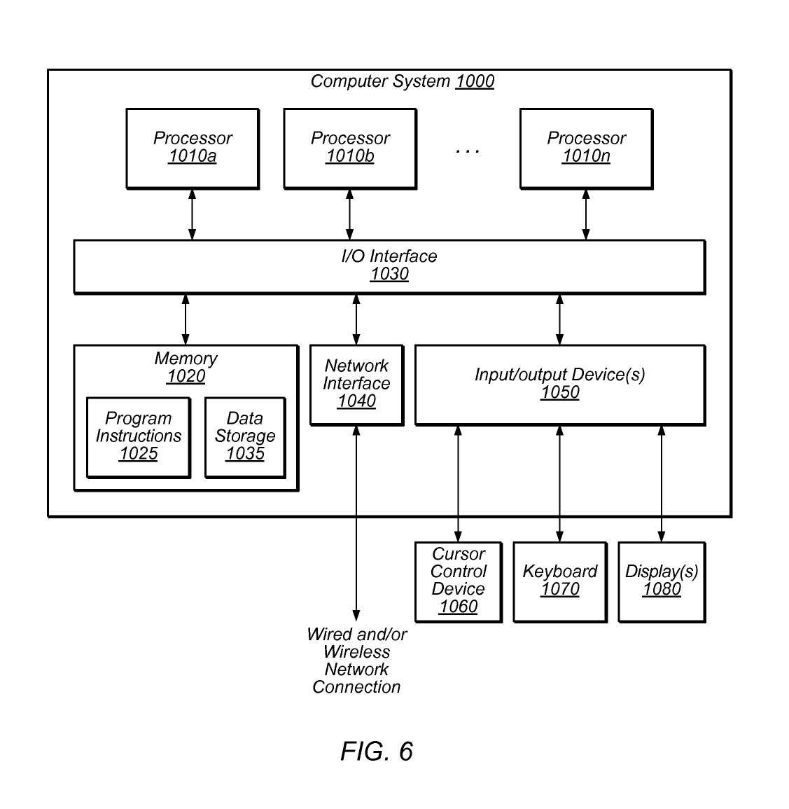

FIG. 6 illustrates a device that may allow for a partial or complete shut down of a graphics pipeline according to the various compositing and sampling techniques, as described herein. The device may interact with various other devices. One such computer system is illustrated by FIG. 6. In different embodiments, computer system 1000 may be any of various types of devices, including, but not limited to, a personal computer system, desktop computer, laptop, notebook, tablet device, or netbook computer, mainframe computer system, handheld computer, workstation, network computer, a camera, television, a set top box, a mobile device, a consumer device, video game console, handheld video game device, application server, storage device, a peripheral device such as a switch, modem, router, or in general any type of computing or electronic device.

Computer system 1000 may include a plurality of hardware resources, such as processor(s) 1010 and input/output device(s) 1050. In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a GPU. A GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the image processing methods disclosed herein may, at least in part, be implemented by program instructions configured for execution on one of, or parallel execution on two or more of, such GPUs. The GPU(s) may implement one or more APIs that permit programmers to invoke the functionality of the GPU(s). Suitable GPUs may be commercially available from vendors such as NVIDIA Corporation, ATI Technologies (AMD), and others.

GPUs, such as one or more of processors 1010 may be implemented in a number of different physical forms. For example, GPUs may take the form of a dedicated graphics card, an integrated graphics solution and/or a hybrid solution. The dedicated graphics card may be a 3D graphics card. GPU 1010 may interface with the motherboard by means of an expansion slot such as PCI Express Graphics or Accelerated Graphics Port (AGP) and thus may be replaced or upgraded with relative ease, assuming the motherboard is capable of supporting the upgrade. However, a dedicated GPU is not necessarily removable, nor does it necessarily interface the motherboard in a standard fashion. The term “dedicated” refers to the fact that hardware graphics solution may have RAM that is dedicated for graphics use, not to whether the graphics solution is removable or replaceable. Dedicated GPUs for portable computers may be interfaced through a non-standard and often proprietary slot due to size and weight constraints. Such ports may still be considered AGP or PCI express, even if they are not physically interchangeable with their counterparts.

Integrated graphics solutions, or shared graphics solutions are graphics processors that utilize a portion of a computer's system RAM rather than dedicated graphics memory. For instance, modern desktop motherboards normally include an integrated graphics solution and have expansion slots available to add a dedicated graphics card later. As a GPU may be extremely memory intensive, an integrated solution finds itself competing for the already slow system RAM with the CPU as the integrated solution has no dedicated video memory. For instance, system RAM may experience a bandwidth between 2 GB/s and 8 GB/s, while most dedicated GPUs enjoy from 15 GB/s to 30 GB/s of bandwidth. Hybrid solutions may also share memory with the system memory, but may have a smaller amount of memory on-board than discrete or dedicated graphics cards to make up for the high latency of system RAM. Data communicated between the graphics processing unit 1010 and the rest of the computer system 1000 may travel through a graphics card slot or other interface, such as I/O interface 1030 of FIG. 5.

Note that program instructions 1025 may be configured to implement a graphics application (e.g., a multimedia player, as described herein) as a stand-alone application, or as a module of another graphics application or graphics library, in various embodiments. For example, in one embodiment program instructions 1025 may be configured to implement graphics applications such as painting, editing, publishing, photography, games, animation, and/or other applications, and may be configured to provide the functionality described herein. In another embodiment, program instructions 1025 may be configured to implement the techniques described herein in one or more functions or modules called by another graphics application executed on GPU 1010 and/or processor(s) 1010 (e.g., a compositing module, and/or a sampling module). These modules may be executable on one or more of CPUs 1010 and/or GPUs 1010 to cause computer system 1000 to provide the functionality described herein. The graphics application may be implemented in various embodiments using any desired programming language, scripting language, or combination of programming languages and/or scripting languages, e.g., C, C++, C#, Java™, Perl, etc. For example, in one embodiment, the graphics application may be JAVA based, while in another embodiments, it may be implemented using the C or C++ programming languages. In other embodiments, the graphics application may be implemented using specific graphic languages specifically for developing programs executed by specialized graphics hardware, such as a GPU. In addition, the graphics application may be embodied on memory specifically allocated for use by graphics processor(s), such as memory on a graphics board including graphics processor(s). Program instructions 1025 may also be configured to render images and present them on one or more displays as the output of an operation and/or to store image data in memory 1020 and/or an external storage device(s), in various embodiments.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for embodiments of a compositing module, and a sampling module are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, or between nodes of computer system 1000. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, support one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040. Input/output devices 1050 may also include a display controller and/or an overlay engine that may be used to sample various media content layers, and composite the sampled layers to provide to display(s) 1080. In one embodiment, a display controller may implement the various disclosed compositing and sampling techniques.

As shown in FIG. 6, memory 1020 may include program instructions 1025, configured to implement embodiments of a compositing module, and a sampling module as described herein, and data storage 1035, comprising various data accessible by program instructions 1025. In one embodiment, program instructions 1025 may include software elements of embodiments of compositing and/or sampling modules as illustrated in the above Figures. Data storage 1035 may include data that may be used in embodiments. In other embodiments, other or different software elements and data may be included.

Those skilled in the art will appreciate that computer system 1000 is merely illustrative and is not intended to limit the scope of compositing and sampling modules, as described herein. In particular, the computer system and devices may include any combination of hardware or software that can perform the indicated functions, including a computer, personal computer system, desktop computer, laptop, notebook, or netbook computer, tablet device, mainframe computer system, handheld computer, workstation, network computer, a camera, a set top box, television, a mobile device, network device, internet appliance, PDA, wireless phones, pagers, a consumer device, video game console, handheld video game device, application server, storage device, a peripheral device such as a switch, modem, router, or in general any type of computing or electronic device. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present disclosure may be practiced with other computer system configurations.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent example embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the disclosure embrace all such modifications and changes and, accordingly, the above description to be regarded in an illustrative rather than a restrictive sense.

What is claimed is:

1. A method, comprising:
receiving multimedia content, wherein the multimedia content comprises a graphics component rendered as a graphics layer and a video component rendered as a video layer;
determining any regions of the graphics layer that include one or more non-transparent objects;
sampling the video layer and the determined regions of the graphics layer without sampling regions of the graphics layer not containing one or more non-transparent objects; and
compositing the sampled video layer and the sampled determined regions of the graphics layer for display.

2. The method of claim 1, wherein said determining, compositing, and sampling include:
determining that the graphics layer includes no non-transparent objects;
sampling the video layer without sampling the graphics layer; and
compositing the sampled video layer for display.

3. The method of claim 1, wherein said determining any regions includes the multimedia player providing a graphics state that indicates a status of any non-transparent objects in the graphics layer to a display controller implementing said sampling.

4. The method of claim 1, wherein said determining any regions comprises:
the multimedia player receiving a display list comprising a plurality of objects; and
the multimedia player determining the regions corresponding to the one or more non-transparent objects of the plurality of objects in the display list.

5. The method of claim 1, further comprising:
in response to said determining, providing an indication of the determined regions to the hardware performing said sampling.

6. The method of claim 1, wherein said sampling and compositing is performed with the same hardware.

7. The method of claim 1, wherein said sampling and compositing are performed with different hardware and wherein the hardware performing said sampling is configured to provide an indication to the hardware performing said compositing to indicate the determined regions to composite for display.

8. The method of claim 1, wherein said sampling the video layer is performed at a different rate than said sampling the graphics layer.

9. The method of claim 1, wherein said compositing includes compositing the sampled video layer and the sampled determined regions of the graphics layer for display in a full-screen mode of a multimedia player.

10. A non-transitory computer-readable storage medium storing program instructions, wherein the program instructions are computer-executable to implement:
for multimedia content comprising a graphics component rendered as a graphics layer and a video component rendered as a video layer:
determining any regions of the graphics layer that include one or more non-transparent objects;
directing sampling the video layer and the determined regions of the graphics layer without sampling regions of the graphics layer not containing one or more non-transparent objects; and
directing compositing the sampled video layer and the sampled determined regions of the graphics layer for display.

11. The non-transitory computer-readable storage medium of claim 10, wherein said determining, compositing, and sampling include:
determining that the graphics layer includes no non-transparent objects;
directing sampling the video layer without sampling the graphics layer; and
directing compositing the sampled video layer for display.

12. The non-transitory computer-readable storage medium of claim 10, wherein said determining any regions includes providing a graphics state that indicates a status of any non-transparent objects in the graphics layer to a display controller implementing said sampling.

13. The non-transitory computer-readable storage medium of claim 10, wherein said determining any regions comprises:
receiving a display list comprising a plurality of objects; and
determining the regions corresponding to the one or more non-transparent objects of the plurality of objects in the display list.

14. The non-transitory computer-readable storage medium of claim 10, wherein said sampling and compositing is performed with the same hardware.

15. The non-transitory computer-readable storage medium of claim 10, wherein said sampling and compositing are performed with different hardware and wherein the hardware performing said sampling is configured to provide an indication to the hardware performing said compositing to indicate the determined regions to composite for display.

16. The non-transitory computer-readable storage medium of claim 10, wherein said sampling the video frame buffer is performed at a different rate than said sampling the display frame buffer.

17. A system, comprising:
a plurality of hardware resources configured to:
receive multimedia content, wherein the multimedia content comprises a graphics component rendered as a graphics layer and a video component rendered as a video layer;
determine any regions of the graphics layer that include one or more non-transparent objects;
sample the video layer and the determined regions of the graphics layer without sampling regions of the graphics layer not containing one or more non-transparent objects; and
composite the sampled video layer and the sampled determined regions of the graphics layer for display.

18. The system of claim 17, wherein to perform said determining, compositing, and sampling, the plurality of hardware resources is further configured to:
determine that the graphics layer includes no non-transparent objects;
sample the video layer without sampling the graphics layer; and
composite the sampled video layer for display.

19. The system of claim 17, wherein one of the plurality of hardware resources is a central processing unit (CPU) configured to execute program instructions to implement the multimedia player and perform said determining, and another one of the plurality of hardware resources is a display controller configured to perform said sampling.

20. The system of claim 19, wherein to perform said determining, the program instructions are further executable by the CPU to:
receive a display list comprising a plurality of objects;
determine the regions corresponding to the one or more non-transparent objects of the plurality of objects in the display list;
and provide the determined regions to the display controller.

21. The system of claim 19, wherein the display controller is further configured to perform said compositing.

22. The system of claim 19, wherein a third one of the plurality of hardware resources is a graphics processing unit configured to perform said compositing, and wherein the display controller is further configured to provide an indication to the GPU to indicate the determined regions of the graphics layer to composite for display.
